(19) United States
(12) Patent Application Publication
(10) Pub. No.: US 2007/0120459 A1
(43) Pub. Date: May 31, 2007

(54) Field emission display device

(75) Inventors: Tzung-Han Yang, Taipei City (TW); Jeng-Maw Chiou, Hsinchu (TW); Shy-Wen Lai, Hsinchu (TW); Cheng-Feng Lin, Hsinchu (TW); Chao-Hsun Lin, Hsinchu (TW)

Correspondence Address: BACON & THOMAS, PLLC, 625 SLATERS LANE, FOURTH FLOOR, ALEXANDRIA, VA, 22314, US

(73) Assignees: Tatung Company, Taipei City (TW); Industrial Technology Research Institute, Hsinchu (TW)

(21) Appl. No.: 11/482,716

(22) Filed: Jul. 10, 2006

(30) Foreign Application Priority Data
Nov. 17, 2005 (TW) 094140466

(51) Int. Cl. H01J 1/62

(52) U.S. Cl. 313/495

(57) ABSTRACT

A field emission display (FED) device, which includes a top substrate, a bottom substrate, and an intermediate plate set located between the top substrate and the bottom substrate. The top substrate has a phosphor layer and an anode. The bottom substrate has a cathode, and an electron emitter. The intermediate plate set has a metal plate with multiple holes, an insulating layer with multiple holes, and a gate layer. In the FED device, the insulating layer is located between the gate layer and the metal plate for electrical insulation, and the gate layer has a gap from the bottom substrate. Thus, the processing steps prepared for the bottom substrate can be reduced to thereby prevent the electron emitters from damage. The number of electrons bombarding on the phosphor layer is effectively increased to thereby increase the brightness and color contrast on pixels.

### BACKGROUND OF THE INVENTION

1. Field of the Invention

The invention relates to flat panel displays and, more particularly, to a field emission display device (FED) capable of protecting electron emitters from damage.

2. Description of Related Art

In recent years, display devices have become increasingly important in life. For example, computers, the Internet, televisions, cellphones, personal digital assistants (PDAs), and digital cameras, all have to exchange messages under the control of a display. As compared to conventional cathode ray tube (CRT) displays, new-generation flat panel displays have the light, small and ergonomic features, but they also have the disadvantages of poor viewing angle, low brightness and high power consumption.

In the developing flat panel display technologies, FEDs have the feature of good images quality the same as the CRT displays and are unlike liquid crystal displays (LCDs) that have the disadvantages of poor viewing angle, small range of operating temperature, and long response time. Generally, an FED can provide the features of high yield, short response time, good communication for display, high brightness over 100 ftL, thinner and lighter structure, wide angle of view, large range of operating temperature, high performance efficiency, and good recognition of slanting direction.

In addition, an FED can be used without a backlight module, and even under the outdoor sunshine, it can provide a satisfactorily high brightness. The developing nanotechnologies have provided novel electron emission materials to FEDs. One of the materials is the carbon nanotube (CNT), which forms a CNT-type FED to replace an electron-tip emission device that has the disadvantages of short lifetime and difficult manufacture. The CNT-type FED is operated upon the principle of CNT-tip discharge. Accordingly, the FEDs compete strongly with the LCDs to the extent of replacing them.

The FEDs have the similar operating principle to the typical CRTs. Namely, at a vacuum environment below 10⁻⁶ torr, an electric field is applied to draw electrons out of the cathode microtips, and the electrons are accelerated by a positive voltage at the anode plate to bombard the phosphor layer on the anode plate so as to generate luminescence. Typically, an FED controls a voltage difference between a cathode and a gate electrode such that each electron emitter emits electrons at the assigned time.

An FED typically includes cathodes, spacers, electron emitters and gate electrodes prepared on a bottom substrate, wherein the electron emitters easily suffer the reduced quality after undergoing a series of processes. Accordingly, in order to comply with the requirement of a high precision FED, it is important to protect the electron emitters from damage.

Therefore, it is desirable to provide an improved FED to mitigate and/or obviate the aforementioned problems.

### SUMMARY OF THE INVENTION

The object of the invention is to provide a field emission display (FED) device, which is prepared by reducing or even eliminating the gate structure to thereby protect an electron emitter from damage and further obtain a better production yield.

According to a feature of the invention, a field emission display (FED) device is provided. The FED device includes a top substrate, a bottom substrate and an intermediate plate set located between the top substrate and the bottom substrate. The top substrate has a phosphor layer and an anode. The bottom substrate has a bottom plate, one or more cathodes, and one or more electron emitters. The intermediate plate set has one or more metal plates with multiple holes, one or more insulating layers with multiple holes, and a gate layer.

In the FED device, the cathodes are located on the bottom plate, and the electron emitters are located on the cathodes. Each insulating layer is located between the gate layer and a metal plate for electrical insulation. The gate layer has a gap from the bottom substrate. Thus, the processing steps prepared for the bottom substrate can be reduced to prevent the electron emitters from damage and to further increase the production yield.

For isolating the influence of a high electric field applied to the electrodes at the top substrate on the electrodes at the bottom substrate, the intermediate plate set preferably includes multiple metal plates, and an insulating layer is located between the metal plates for electrical insulation and easy control in operation.

In the FED device, the holes of the metal plates can be arranged in any pattern. Preferably, a pattern of M×N matrix is arranged, for M, N are an integer greater than zero. The holes of the metal plates can be in any shape, but a tetragon, round, polygon, irregular shape, or a combination thereof is preferred. Besides, the holes of the metal plates can be patterned into trenches in parallel to one another, i.e., the metal plates can be discontinuous metal plates.

In the FED device, the holes of the insulating layers can be arranged in any pattern. Preferably, a pattern of M×N matrix is arranged, for M, N are an integer greater than zero. The holes of the insulating layers can be in any shape, but a tetragon, round, polygon, oval, irregular shape, or a combination thereof is preferred. Besides, the holes of the insulating layers can be patterned into trenches in parallel to one another, i.e., the insulating layers can consist of discontinuous insulator.

The gate electrodes can be any gate electrodes suitable for a typical planar FED, but a plurality of ring-shaped gate electrodes with holes, a gate plate with multiple holes, or a plurality of stripe-shaped gate electrodes are preferred. The ring-shaped gate electrodes can be arranged in any form and have a one-to-one relation with respect to the electron emitters, such that each electron emitter can accurately emit electrons at an assigned time.

In a preferred manner of the invention, the metal plates, the insulating layers and the gate layer of the intermediate plate set are formed in a stack, wherein the gate layer is arranged the closest to the bottom substrate and has a gap from the bottom substrate, and an insulating layer is sandwiched in between the gate layer and a metal plate. Besides, an insulating layer is preferably sandwiched in between the metal plates, and the heights of the insulating layers are adjusted with the interlayer distance between the metal plates. The location and number of metal plates are not limited but depend on the process needs.

In another preferred manner of the invention, the holes of the insulating layers and the metal plates can be matched to thus have the same arrangement and pattern. Similarly, the gate layer can be matched with the pattern of the holes of the metal plates according to the process needs. As the gate layer consists of the ring-shaped gate electrodes with holes, the holes preferably have a shape as same as that of the metal plates. As the gate layer is the gate plate with the holes, the holes preferably have a shape the same as that of the metal plates.

The holes of the metal plates can be in any arrangement with respect to the top and bottom substrates. In a preferred embodiment of the invention, when the electron emitters of the bottom substrate are formed in a dot shape, the holes of the metal plates and the electron emitters have a one-to-one arrangement, but are not limited to it. For example, the holes of the metal plates and the electron emitters can be in a one-to-multiple or multiple-to-one arrangement, depending on the shapes of the electron emitters and the metal plates, or the manufacturing cost.

Besides, the cathodes can be in any shape, but preferably are in a dot shape, a continuous or a discontinuous stripe shapes. The cathodes can be formed of any material suitable for the cathode of a typical FED.

Since each pixel of the FED has a respective field emission array, and the electron emitters emit electrons by applying an external bias voltage between the cathodes and the gate electrodes, the structures of the gate electrodes, the cathodes and the electron emitters can be correspondingly matched in shape to thereby control the accurate time of emitting electrons by each electron emitter and further the display time for each pixel.

For the holes of the metal plates, the aperture diameter can be equal or not equal to the inner diameter. The inner surfaces (wall surfaces) of the holes can be in any pattern, but preferably are of a pattern selected from the group of vertical, slanting, concave-slanting, convex-slanting surface, and combinations thereof, and more preferably are a combination of upward and downward concave-slanting surfaces.

The metal plates can be any kind of metal plate, but preferably they are formed of a sheet metal coated on a surface with an electron amplification material. The electron amplification material can be a metal alloy such as silver-magnesium alloy, copper-beryllium alloy, copper-barium alloy, gold-barium alloy, gold-calcium alloy, tungsten-barium-gold alloy, ferro-nickel alloy or the combination thereof; or a metal oxide such as oxides of beryllium, oxides of magnesium, oxides of calcium, oxides of strontium, oxides of barium or the combination thereof.

Electrons emitted by the electron emitters are accelerated, due to a voltage difference between the top substrate and the bottom substrate, to move from the bottom substrate to the top substrate and bombard on the phosphor layer particles of the phosphor to accordingly generate a light visible to human eye.

Since the number and distribution uniformity of electrons are a key of lighting brightness and illumination uniformity, the invention applies an on-demand voltage, other than the voltages of the anode and the cathode, to effectively increase the number of electrons to generate the secondary electrons through the metal plates, or effectively focus the electrons emitted on targets. Accordingly, the number of electrons bombarding into the phosphor layer is increased, and the entire brightness and color contrast of pixels are increased.

In the invention, for enhancing the stability and solid support capability of the entire FED structure, the FED device can further include one or more spacers located on two sides between the top substrate and the bottom substrate to accordingly support the gap distance between the intermediate plate set and the top and bottom substrates. Alternatively, the side of the gate layer facing the bottom substrate can selectively include an insulating spacer to maintain a gap and provide the solid support effect. In addition, the side of the metal plate the closest to the top substrate can further include an insulating spacer to provide the solid support effect.

The insulating spacers can be formed of any typical insulating material.

The electron emitters can be applied to any typical FED, but preferably are of a carbon nanotube (CNT)-type FED. The electron emitters can be formed of any typical material capable of emitting electrons, but preferably are of a carbon-based material selected from the group of black lead, diamond, diamond-like carbon, carbon nanotube (CNT), carbon 60 and the combination thereof. In a preferred embodiment of the invention, the FED device uses a CNT as an electron emitter.

The FED device further includes a shield layer on the top substrate to tightly surround the phosphor layer for preventing the light leakage or increasing the color contrast. The bottom substrate further includes one or more switches, which are connected to the cathodes for driving the electron emitters on the cathodes. The switches can be any typical passive or active driving switch, but preferably are of a thin film transistor (TFT), thin film diode, or a matrix scanning drive circuit.

In the invention, the structure of the FED device is improved to prevent the electron emitters from damage, effectively focus or increase the electrons bombarding the phosphor layer. Accordingly, the entire brightness and color contrast of pixels are enhanced.

Other objects, advantages, and novel features of the invention will become more apparent from the following detailed description when taken in conjunction with the accompanying drawings.

### BRIEF DESCRIPTION OF THE DRAWINGS

FIG. 1 is a schematic cross-section view of a field emission display (FED) device according to a preferred embodiment of the invention;

FIG. 2 is a schematic cross-section view of a field emission display (FED) device according to a preferred embodiment of the invention;

FIG. 3 is a schematic cross-section view of an intermediate plate set according to a preferred embodiment of the invention;

FIG. 4 is a schematic cross-section view of an intermediate plate set according to a preferred embodiment of the invention;

FIG. 5 is a schematic cross-section view of an intermediate plate set according to a preferred embodiment of the invention; and

FIG. 6 is a schematic cross-section view of an intermediate plate set according to a preferred embodiment of the invention.

### DETAILED DESCRIPTION OF THE PREFERRED EMBODIMENT

### First Embodiment

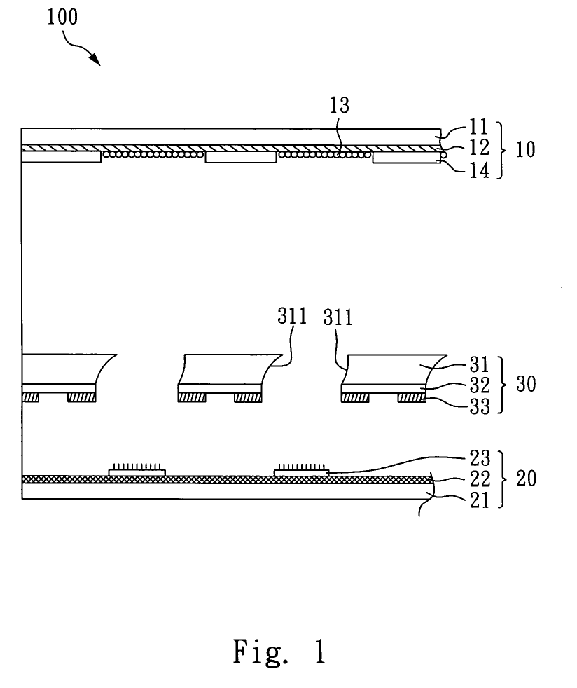

FIG. 1 is a schematic cross-section view of a field emission display (FED) device 100 according to a preferred embodiment of the invention. In FIG. 1, the FED device 100 includes a top substrate 10 having a transparent plate 11, an anode 12, a phosphor layer 13 and a shield layer 14; a bottom substrate 20 having a bottom plate 21, multiple stripe-shaped cathodes 22 and multiple dot-distributed electron emitters 23; and an intermediate plate set 30 located between the top substrate 10 and the bottom substrate 20. The intermediate plate set 30 has one or more metal plates 31 with multiple round matrix holes, an insulating layer 32 with multiple round matrix holes, and a gate layer 33 with round holes. The gate electrodes 33 are separated from the bottom substrate 20 by a gap.

The phosphor layer 13 is formed of a phosphor or light-emitting material. The transparent plate 11 is of a glass or other transparent material. The anode 12 is formed of a transparent and electrically conductive material such as an indium-tin-oxide (ITO) or indium-zinc-oxide (IZO). The electron emitters 23 are formed of a carbon nanotube (CNT) material. The insulating layer 32 is formed of an insulating material such as the aluminum oxide or the magnesium oxide.

The stripe-shaped cathodes 22 are arranged in parallel on the bottom plate 21. The electron emitters 23 are formed on the cathodes 22 in a form of dot distribution.

It is to be noted that the structures of the cathodes 22 and the gate electrodes 33 can be in an alternative form, not limited to the aforementioned. For example, if the gate layer consists of the ring-shaped gate electrodes 33 with round holes, the cathodes 22 can be formed or distributed in a pattern of dots, discontinuous stripes or other typical cathode forms. If the gate layer is a gate plate with holes, the cathodes 22 are matched in a discontinuous shape such as a dot or stripe form to separately control each electron emitter on the cathodes to emit electrons at the assigned time.

The metal plates 31, the insulating layer 32 and the ring-shaped gate electrodes 33 are formed into a stack, and the insulating layer 32 is sandwiched in between the metal plates 31 and the ring-shaped gate electrodes 33 for electrical insulation. The holes of the insulating layer 32 and the ring-shaped gate electrodes 33 are patterned to match with the metal plates 31 on the shape and the arrangement, and correspond to the electron emitters 23 in a one-to-one manner. Such an arrangement is only an example, and the alternatives can be given by those skilled in the prior art.

A voltage difference between the cathodes 22 and the gate electrodes 33 is controlled to separately control each electron emitter 23 to emit electrons at an assigned time, so as to further control the time of a color light generation by the phosphor layer 13 corresponding to the electron emitter 23. In addition, the electrons emitted by the electron emitter 23 and influenced by the voltage difference are accelerated toward the top substrate 10 and bombard on the phosphor layer 13 to react with the phosphor material and generate a visible light. The visible light is viewable by human eye when the light travels through the transparent plate 11 to the outside.

The surfaces of the metal plates 31 are coated with a ferro-nickel or silver-magnesium alloy for electron amplification, and the round matrix holes thereof correspond to the electron emitters 23 in a one-to-one manner. In this case, electrons pass through the intermediate plate set 30 and bombard on the electron amplification material coated on the surfaces of the metal plates 31 when moving from the bottom substrate 20 to the top substrate 10 due to an external bias voltage, so as to obtain the doubled number of electrons (secondary electrons). In addition, the metal plates 31 can isolate the influence of the high electric field from the anode 12 of the top substrate 10 on the cathodes 22 of the bottom substrate 20. Further, an additional potential can be applied to the metal plates 31 to focus the electrons for more effective bombarding.

As shown in FIG. 1, the holes of the metal plates have different inner diameters and different aperture diameters. In addition, the inner surfaces 311 (wall shapes) of the holes consist of a concave-slanting surface and a convex-slanting surface in order to increase the bombarding areas when the electrons pass through the metal plates 31.

In this embodiment, the process for the top substrate 10 and the bottom substrate 20 can be any process for preparing typical FED top and bottom substrates. For example, a screen printing, sputtering, coating, lithography or etching technique can be used to form the FED device. In addition, in such a structure, the processing steps for the invention can be reduced to thus reduce the electron emitter from damage and obtain a better production yield.

### Second Embodiment

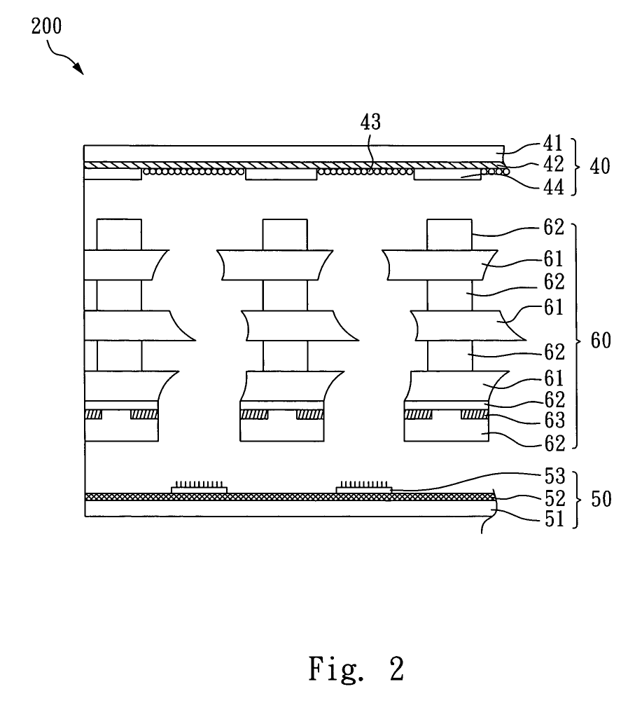

FIG. 2 is a schematic cross-section view of a field emission display (FED) device 200 according to a preferred embodiment of the invention. In FIG. 2, the FED device 200 includes a top substrate 40, a bottom substrate 50 and an intermediate plate set 60. In this embodiment, the top and bottom substrates 40 and 50 have structures identical to the respective substrates 10 and 20, and the intermediate plate set 60 also includes the metal plates 61, the insulating layer 62 and the ring-shaped gate electrodes 63, but the elements of the set 60 have a different arrangement than those of the first embodiment.

As shown in FIG. 2, the structure of the intermediate plate set 60 is extended from the intermediate plate set 30 of the first embodiment in which only a layer of metal plates is shown. In this embodiment, two layers of metal plates are added above the layer of metal plates shown in the intermediate plate set 30, and an insulating spacer 62 is disposed between the metal plates for electrical insulation. In addition, an insulating spacer 62 is disposed respectively on the top and the bottom of the intermediate plate set 60 for supporting the entire space configuration and maintaining the gaps between the intermediate plate set 60 and the top and bottom substrates to thereby provide a stable solid support.

The multi-layer structure of the set 60 can increase the bombarding frequency of electrons to further generate more secondary electrons for bombarding the phosphor layer. Accordingly, the FED device can have the feature of high brightness, even with a low driving voltage.

### Third Embodiment

This embodiment is identical to the first embodiment except the intermediate plate set 30. The intermediate plate set 30 includes a gate plate with multiple holes, as shown in FIG. 3. The holes of the gate plate have a round pattern the as same as the holes of the metal plates. In addition, in order to separately control each electron emitter to emit electrons at the assigned time, the cathodes are arranged or distributed in a pattern of dots or discontinuous stripe.

### Fourth to Sixth Embodiments

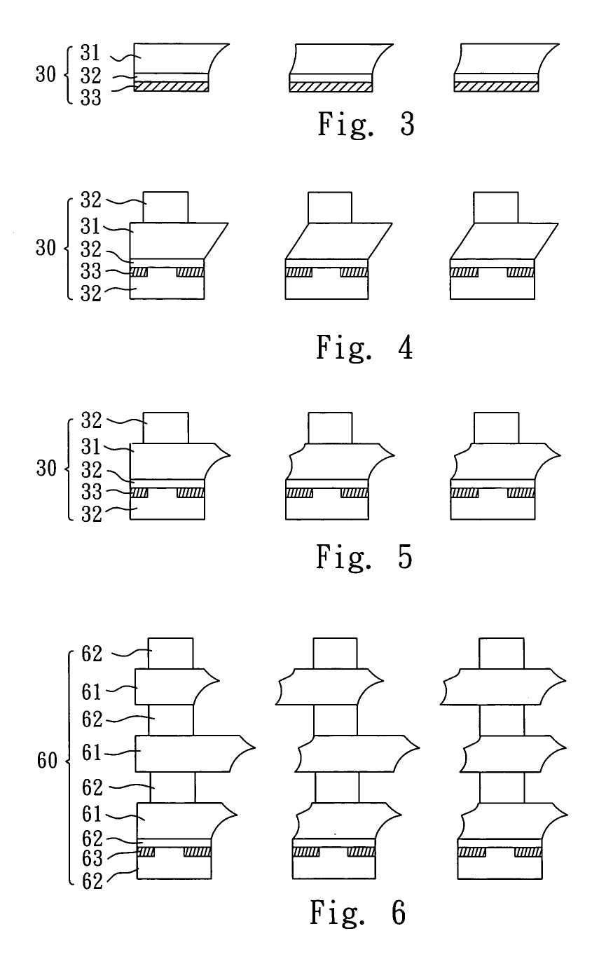

As cited, the metal plates of the FED device can have the holes with same or different inner diameters and aperture diameters. The inner surfaces (wall surfaces) of the holes can be in any pattern, but preferably are in a pattern selected from the group of vertical, slanting, concave-slanting, convex-slanting surface, and combinations thereof. Accordingly, the structures of the intermediate plate sets are selectively formed of vertical, slanting, concave-slanting, convex-slanting surface and the combinations, as shown in FIGS. 4 to 6. In addition, the inner diameter and the aperture diameter are the same in FIG. 4 and not the same as in FIGS. 5 and 6. Accordingly, the intermediate plate set can be arranged adaptively upon the requirements of low driving voltage, high electron amplification effect and low manufacturing cost.

As cited, upon the structure of the FED device, the process for the bottom substrate can be simplified to thereby prevent the electron emitters from damage and obtain a better production yield to benefit the market competition.

Although the present invention has been explained in relation to its preferred embodiment, it is to be understood that many other possible modifications and variations can be made without departing from the spirit and scope of the invention as hereinafter claimed.

What is claimed is:

1. A field emission display (FED) device, comprising:
a top substrate, which has a phosphor layer and an anode;
a bottom substrate, which has a bottom plate, one or more cathodes on the bottom plate, and one or more electron emitters on the cathodes; and
an intermediate plate set between the top substrate and the bottom substrate, which has one or more metal plates with multiple holes, one or more insulating layers with multiple holes, and a gate layer;
wherein the insulating layer is disposed between the gate layer and the metal plates, and the gate layer has a gap from the bottom substrate.

2. The FED device as claimed in claim 1, wherein the intermediate plate set comprises the metal plates, and an insulating layer is disposed between the metal plates.

3. The FED device as claimed in claim 1, wherein the holes of the metal plates are arranged in a pattern of M×N matrix, for M, N are an integer greater than zero.

4. The FED device as claimed in claim 1, wherein the holes of the insulating layers are arranged in a pattern of M×N matrix, for M, N are an integer greater than zero.

5. The FED device as claimed in claim 1, wherein the holes of the metal plates and the insulating layers are arranged in a pattern respectively selected from a group of tetragon, round, polygon, irregular shape, and combinations thereof.

6. The FED device as claimed in claim 1, wherein the holes of the metal plates and the insulating layers have a same pattern.

7. The FED device as claimed in claim 1, wherein the holes of the metal plates have same inner and aperture diameters.

8. The FED device as claimed in claim 7, wherein the holes have a pattern selected from a group of vertical, slanting, concave-slanting, convex-slanting surface, and combinations thereof.

9. The FED device as claimed in claim 1, wherein the holes of the metal plates have different inner and aperture diameters.

10. The FED device as claimed in claim 9, wherein the holes have a pattern selected from a group of vertical, slanting, concave-slanting, convex-slanting surface, and combinations thereof.

11. The FED device as claimed in claim 1, wherein the gate layer consists of ring-shaped gate electrodes with holes.

12. The FED device as claimed in claim 11, wherein the holes of the ring-shaped gate electrodes and the metal plates have a same pattern.

13. The FED device as claimed in claim 1, wherein the gate layer is a gate plate with holes.

14. The FED device as claimed in claim 13, wherein the holes of the ring-shaped gate electrodes and the metal plates have a same pattern.

15. The FED device as claimed in claim 1, wherein the metal plates are formed of a sheet metal on which surface an electron-amplification material is coated.

16. The FED device as claimed in claim 16, wherein the electron-amplification material is an alloy selected from a group of silver-magnesium alloy, copper-beryllium alloy, copper-barium alloy, gold-barium alloy, gold-calcium alloy, tungsten-barium-gold alloy, ferro-nickel alloy, and combinations thereof.

17. The FED device as claimed in claim 16, wherein the electron-amplification material is an oxide selected from a group of oxides of beryllium, oxides of magnesium, oxides of calcium, oxides of strontium, oxides of barium, and combinations thereof.

18. The FED device as claimed in claim 1, wherein the cathodes are formed of an electrically conductive material in a stripe-shaped pattern.

19. The FED device as claimed in claim 1, wherein the electron emitters are formed of a carbon-based material selected from a group of black lead, diamond, diamond-like carbon, carbon nanotube (CNT), carbon 60 and combinations thereof.
